(19) United States
(12) Patent Application Publication
(10) Pub. No.: US 2022/0294944 A1
(43) Pub. Date: Sep. 15, 2022

(54) LENS DRIVING DEVICE, CAMERA DEVICE AND ELECTRONIC APPARATUS

(71) Applicant: New Shicoh Motor Co., LTD, Zhejiang (CN)

(72) Inventor: Kazuhiko NAITO, Yamato City (JP)

(21) Appl. No.: 17/690,597

(22) Filed: Mar. 9, 2022

(30) Foreign Application Priority Data
Mar. 10, 2021 (CN) 202110258941.5

(51) Int. Cl. H04N 5/225; H04M 1/02

(52) U.S. Cl. CPC H04N 5/2254; H04M 1/0264; G03B 13/36

(57) ABSTRACT

A lens driving device includes a fixed body, a movable body, a driving shaft, and a guide shaft. The driving shaft is attached to the fixed body in a free reciprocating asymmetric microvibration manner and the guide shaft is separated from the driving shaft and fixed to the fixed body. The movable body holds the driving shaft by pinching and clamping the driving shaft with a spring member and is engaged with the guide shaft. Between the driving shaft and the guide shaft, one of the fixed body and the movable body comprises a magnet, and the other comprises a soft magnetic member that attracts the magnet.

### CROSS-REFERENCE TO RELATED APPLICATIONS

This application claims priority to Chinese Patent Application No. 202110258941.5 filed Mar. 10, 2021, which is hereby incorporated by reference herein in its entirety.

### TECHNICAL FIELD

The present disclosure relates to a lens driving device used in electronic apparatus such as smartphones, a camera device, and an electronic apparatus.

### BACKGROUND

In some camera devices with an AF (Auto Focus) function, a piezoelectric element is used as a driving source of a movable member that holds a lens body. As a document disclosing a technique related to this type of camera device, Korean registration patent No. 1483782B (hereinafter referred to as “Patent Document 1) can be given. In the focal distance adjustment module of the lens described in this Document 1, the movable body that holds the lens is accommodated on the base, the movable body is held by the driving shaft and the guide shaft that rise from two corner portions on the base, and the movable body is moved in the direction of the optical axis by advancing and retreating of the driving shaft. In addition, in this focal distance adjustment module, the magnet and magnetic material are arranged on the inner wall of the base and the outer wall of the movable body, and the movable body is pressed against the driving shaft and the guide shaft so as not to be inclined by the magnetic attraction force between the magnet and the magnetic material.

### SUMMARY

However, in the lens driving devices of recent years, the stroke amount and the lens weight of the movable body are increased. When the stroke amount and the lens weight of the movable body are increased, in the technique of Patent Document 1, in order to maintain the posture of the movable body, it is necessary to increase the attraction force between the magnet and the magnetic material. Therefore, there is a problem that the force for pressing the movable body against the driving shaft and the guide shaft is also increased and the movable body becomes difficult to move smoothly.

The present disclosure has been made in view of such a problem, and present disclosure aims to provide a lens driving device in which a movable body moves smoothly.

In order to solve the above-described mentioned problem, in accordance with a first aspect of the present disclosure, there is provided a lens driving device including a fixed body, a movable body, a driving shaft, and a guide shaft. The driving shaft is attached to the fixed body in a free reciprocating asymmetric microvibration manner. The guide shaft is separated from the driving shaft and fixed to the fixed body. The movable body holds the driving shaft by pinching and clamping the driving shaft with a spring member, and is engaged with the guide shaft. Between the driving shaft and the guide shaft, one of the fixed body and the movable body has a magnet, and the other has a soft magnetic member that attracts the magnet.

In accordance with a second aspect of the present disclosure, there is provided a camera device including the lens driving device described above.

In accordance with a third aspect of the present disclosure, there is provided an electronic apparatus including the camera device described above.

Further features of the present invention will become apparent from the following description of exemplary embodiments (with reference to the attached drawings).

### BRIEF DESCRIPTION OF THE DRAWINGS

FIG. 1 is a front view of a smartphone on which a camera device including a lens driving device according to one embodiment of the present disclosure is mounted;

FIG. 2 is a perspective view of the lens driving device shown in FIG. 1;

FIG. 3 is an exploded perspective view of the lens driving device shown in FIG. 2;

FIG. 4 is a perspective view in which the case is removed from the lens driving device shown in FIG. 2; and

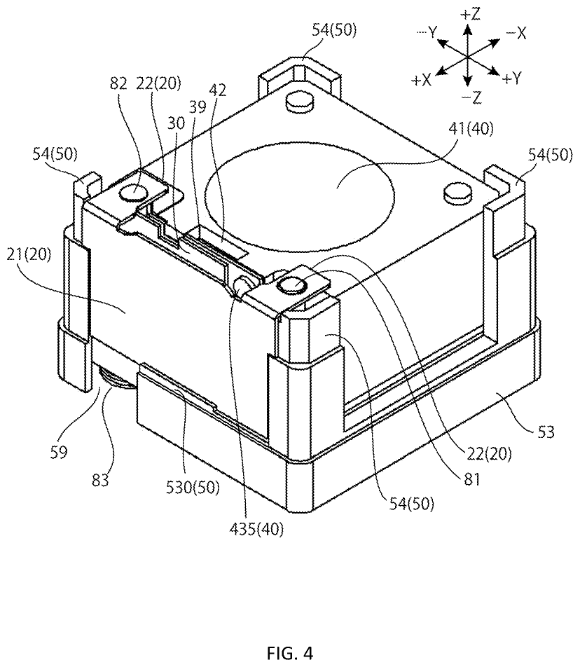

FIG. 5 is a perspective view in which the magnetic substance plate is removed from the lens driving device shown in FIG. 4.

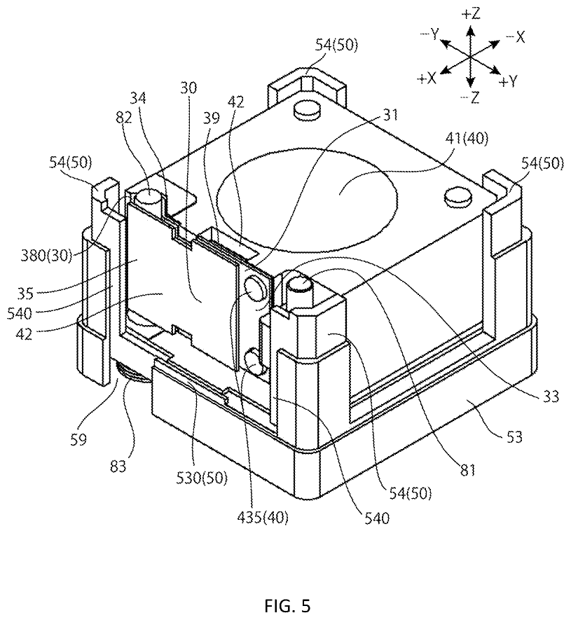

### DETAILED DESCRIPTION

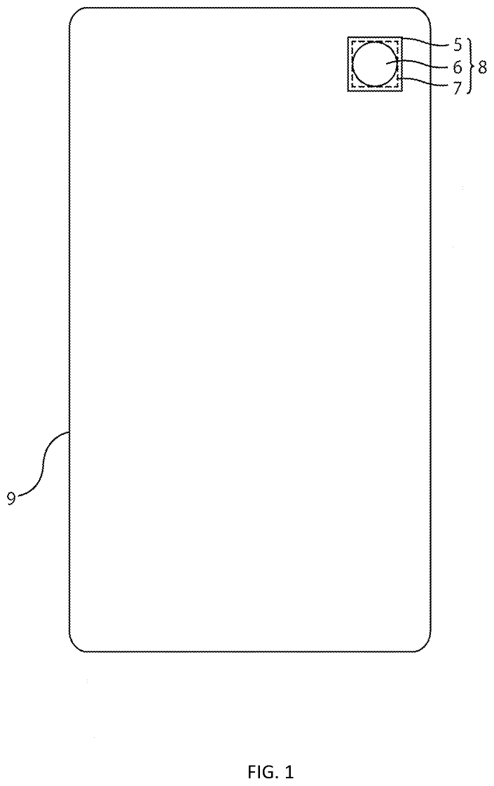

Hereinafter, embodiments of the present disclosure are explained with reference to drawings. As shown in FIG. 1, a camera device 8 including a lens driving device 5 according to one embodiment of the present disclosure is accommodated in a smartphone 9.

The camera device 8 includes: a lens body 6; an image sensor 7 converting light incident through the lens body 6 into an image signal; and a lens driving device 5 holding the lens body 6 and the image sensor 7 and driving the lens body 6 with respect to the image sensor 7.

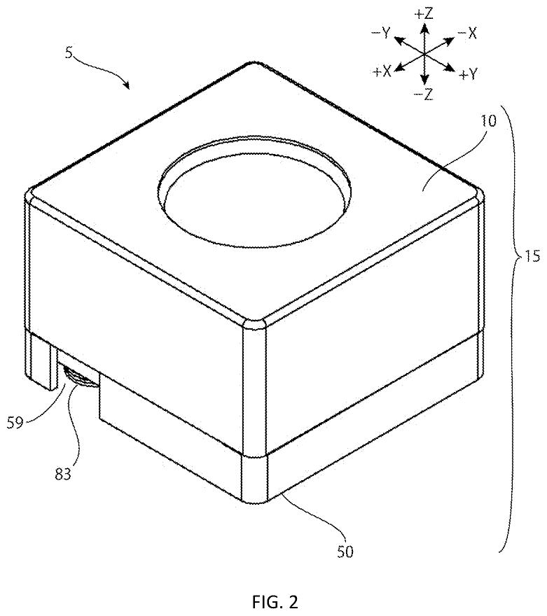

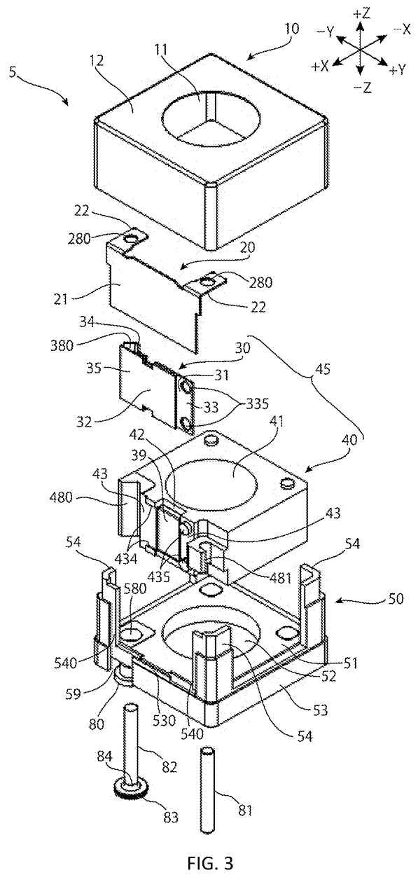

Hereinafter, as shown in FIGS. 2 and 3, the direction in which the light from the subject is incident is appropriately referred to as a Z direction, one direction orthogonal to the Z direction is appropriately referred to as an X direction and a direction orthogonal to both the Z direction and the X direction is appropriately referred to as a Y direction. Further, the +Z side of the optical axis of the lens body 6, which is the side of the subject, may be referred to as a front side, and the −Z side, which is the side on which the image sensor 7 on the opposite side of the subject is provided, may be referred to as a rear side. Further, the −Y side may be referred to as a left side, the +Y side may be referred to as a right side, the −X side may be referred to as an upper side, and the +X side may be referred to as a lower side.

The lens driving device 5 includes a case 10, a magnetic substance plate 20, a spring member 30, a magnet 39, a lens holding portion 40, a base 50, a rubber bush 80, a guide shaft 81, a driving shaft 82, and a vibration member 83. Among these, the case 10, the magnetic substance plate 20, and the base 50 constitute a fixed body 15. The spring member 30, magnet 39, and the lens holding portion 40 constitute a movable body 45.

As shown in FIG. 3, the case 10 is in a box shape with one surface opened. A through hole 11 is provided in the center of the front plate 12 of the case 10.

The base 50 has a bottom plate 51 and is in a rectangular plate-like shape. A through hole 52 is provided in the center of the bottom plate 51. The image sensor 7 is fixed on the rear side of the base 50 with its light receiving surface facing the through hole 52 side. A side plate 53 is formed rearward around the bottom plate 51 except for the opening portion 59. Four column portions 54 extending forward are provided at four corners of the front surface of the bottom plate 51. The column portion 54 is bent in an L shape along the corner of the base 50 as viewed from the Z direction. The column portion 54 has a dual structure, and the inner portion is designed further forward than the outer portion. The inner portions of two column portions 54 on the +X+Y side and the +X−Y side extend further toward the other sides to form a first placing portion 540, respectively. The two first placing portion 540 are formed on the same plane.

The front surface of the bottom plate 51 between the two column portions 54, 54 are provided at slightly low positions with respect to the front surface of the bottom plate 51 around the through hole 52. A front surface is further provided on the outermost edge of the bottom plate 51 including the outer side of each column portion 54, and this position is further lowered, the rear surface of the case 10 is placed and fixed at the front surface. Two round holes 580 are provided inside the two column portions 54 on the +X+Y side and the +X−Y side of the base 50. At the center of the lower edge of the front surface between the two column portions 54, 54 where the first placing portions 540 are formed, the support plate 530 is provided to extend forward. When viewed from the Y direction, an interval corresponding to the thickness of the magnetic substance plate 20 described later is provided between the first placing portion 540 and the support plate 530.

The lens holding portion 40 is in an approximately rectangular parallelepiped shape. The lens holding portion 40 is provided with a through hole 41 for fixing the lens body 6. At the center of the lower surface of the lens holding portion 40, a magnet accommodation portion 42 is recessed upward and a magnet 39 is fixed. The second placing portions 43 are provided on the left and right sides of the magnet accommodation portion 42, and the magnet 39 accommodated in the magnet accommodation portion 42 is further recessed than the second placing portion 43. The two second placing portions 43 are formed on the same plane. Convex portions 434 are provided to protrude downward at the front end and the rear end of the second placing portion 43 on the left side. Two positioning protrusions 435 arranged at front and rear are provided to protrude downward at the second placing portion 43 on the right side.

A groove 480 recessed in a V-shape and extending in the front and rear direction is provided on the left side of the second placing portion 43 on the left side. A hook portion 481 formed in a U-shape opened in the +Y direction and extending in the front and rear direction is provided on the right side of the second placing portion 43 on the right side.

As the soft magnetic member, the magnetic substance plate 20 is a plate body made of a material having soft magnetism of high saturation magnetic flux density, such as iron. The magnetic substance plate 20 has a rectangular portion 21 and end plate portions 22 bent and extending upward from the left and right edges of the front side of the rectangular portion 21. The end plate portion 22 is provided with a round hole 280. The rear side portions of the left and right ends of the rectangular portion 21 are formed to have a slightly narrow width.

The magnetic substance plate 20 is placed and adhesively fixed to the first placing portions 540 of the two column portions 54 on the +X+Y side and the +X−Y side and abuts against the front surface between the two column portions 54. At this time, the lower surface of the magnetic substance plate 20 substantially touches against the upper surface of the support plate 530. It may be adhesively fixed at each abutting spot.

The spring member 30 is formed by bonding two plates, the receiving plate 31 and the pressing plate 32. The receiving plate 31 has a flat plate portion 33 and a groove portion 34. The flat plate portion 33 has positioning holes 335 corresponding to the positioning protrusions 435, and is placed on the two second placing portions 43, 43. The groove portion 34 is formed in a V-shape so as to fit into the groove 480. The receiving plate 31 is adhesively fixed to the second placing portions 43, 43 and the groove 480. The pressing plate 32 is a flat plate, and when it is bonded to the receiving plate 31, the position corresponding to the groove portion 34 becomes the pressing portion 35. In the spring member 30, the positions corresponding to the convex portions 434, 434 are recessed forward or rearward, respectively. A triangular gap 380 is formed between the groove portion 34 and the pressing portion 35, and a driving shaft 82 described later is inserted so as to press and widen the gap 380. That is, the lens holding portion 40 holds the driving shaft 82 by pressing and pinching the driving shaft 82 against the groove portion 34 with the pressing portion 35 to clamp the driving shaft 82.

In the spring member 30, at least the pressing plate 32 has elasticity. Further, at least one of the receiving plate 31 or the pressing plate 32 is made of a material having soft magnetism as a second soft magnetic member, and has a saturation magnetic flux density smaller than the saturation magnetic flux density of the material constituting the magnetic substance plate 20. In particular, a low saturation magnetic flux density of 1.5T or less is desirable, and as such a material, for example, stainless steel having magnetism can be given.

A guide shaft 81 is passed through the round hole 580 on the +X+Y side of the base 50. The rear edge of the guide shaft 81 is fixed to the round hole 580 on the +X+Y side. The front edge of the guide shaft 81 is fixed to the round hole 280 on the right side of the magnetic substance plate 20. The lens holding portion 40 is engaged with the guide shaft 81 via the inner surfaces on the upper side and the lower side of the hook portion 481.

The driving shaft 82 is passed through the round hole 580 on the +X-Y side of the base 50 via a rubber bush 80. The rubber bush 80 has a ring shape, the outer side is fitted into this round hole 580, and the inner side is fitted with the driving shaft 82. The rear end of the driving shaft 82 penetrates the rubber bush 80 and is connected to a vibration member 83 by an adhesive 84. The vibration member 83 is formed by bonding a piezoelectric thin plate and an elastic thin plate. An electrical circuit (not shown) is provided to the piezoelectric thin plate through the opening portion 59.

The front end of the driving shaft 82 is fixed to the round hole 280 on the left side of the magnetic substance plate 20. The driving shaft 82 is held by the lens holding portion 40 by the spring member 30. The groove portion 34 of the spring member 30 and the inner surface of the pressing portion 35 are frictionally engaged with the driving shaft 82.

The magnet 39 provided on the lens holding portion 40 and the magnetic substance plate 20 attract each other. Therefore, since the lens holding portion 40 is pressed against the guide shaft 81 and the driving shaft 82, it is easy to maintain the posture. Further, since the spring member 30 configured by including a soft magnetic material exhibiting relatively weak magnetism is arranged between the magnet 39 and the magnetic substance plate 20, and the magnetic attraction force of the magnet 39 to the magnetic substance plate 20 is weakened by an appropriate amount, the magnetic attraction force becomes sufficiently small with respect to the driving force of the driving shaft 82 by the vibration member 83 described later.

When a predetermined pulse voltage is repeatedly applied to the piezoelectric thin plate of the vibration member 83, the piezoelectric thin plate expands and contracts, whereby the vibration member 83 is finely deformed, and accordingly, the driving shaft 82 repeats the fine reciprocating movement in the Z direction. For example, when the duty ratio of this pulse is changed from 50%, the driving shaft 82 moves at a low speed in the +Z direction and at a high speed in the −Z direction. Hereby, the lens holding portion 40 repeats such a movement that it follows and moves when the driving shaft 82 moves in the +Z direction and cannot follow but remains at the position when the driving shaft 82 moves in the −Z direction, and moves in the +Z direction intermittently. An opposite operation occurs when the duty ratio is reversely changed from 50%.

The above is the details of the present embodiment. The lens driving device 5 in the present embodiment is provided with a fixed body 15 including a case 10, a magnetic substance plate 20 and a base 50, a movable body 45 including a spring member 30, a magnet 39 and a lens holding portion 40, a driving shaft 82, and a guide shaft 81. The driving shaft 82 is attached to the fixed body 15 in a free reciprocating asymmetric microvibration manner. The guide shaft 81 is separated from the driving shaft 82 and fixed to the fixed body 15. The movable body 45 holds the driving shaft 82 by pinching and clamping the driving shaft 82 with a spring member 30, and is engaged with the guide shaft 81. Between the driving shaft 82 and the guide shaft 81, the magnet 39 attached to the lens holding portion 40 is drawn toward the magnetic substance plate 20 attached to the base 50. Thereby, the movable body 45 is supported by the driving shaft 82 and the guide shaft 81 in addition to the attraction force between the magnet 39 and the magnetic substance plate 20, so that it is easy to maintain the posture, and it is possible to provide a lens driving device 5 in which the movable body 45 moves smoothly.

It is to be noted that, in the above embodiment, the magnet 39 may be provided at the fixed body 15 and the magnetic material may be provided at the movable body 45.

Further, the magnetic substance plate 20 may be replaced with a second magnet that attracts the magnet 39. When the magnet is provided on the fixed body 15, a plate having the same shape as the magnetic substance plate 20 may be arranged at the position of the magnetic substance plate 20 and the driving shaft 82 and the guide shaft 81 may be fixed.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A lens driving device comprising:
a fixed body;
a movable body;
a driving shaft; and
a guide shaft,
wherein the driving shaft is attached to the fixed body in a free reciprocating asymmetric microvibration manner,
the guide shaft is separated from the driving shaft and fixed to the fixed body,
the movable body holds the driving shaft by pinching and clamping the driving shaft with a spring member, and is engaged with the guide shaft, and
between the driving shaft and the guide shaft, one of the fixed body and the movable body comprises a magnet, and the other comprises a soft magnetic member that attracts the magnet.

2. The lens driving device according to claim 1, wherein the spring member comprises the second soft magnetic member, and is arranged between the magnet and the soft magnetic member.

3. The lens driving device according to claim 2, wherein a saturation magnetic flux density of the second soft magnetic member is smaller than a saturation magnetic flux density of the soft magnetic member.

4. The lens driving device according to claim 1, wherein:
the fixed body comprises a bottom plate, two column portions extending from corner portions of the bottom plate, and a support plate extending from the bottom plate between the two column portions, and
the soft magnetic member is a plate body, left and right ends of one plate surface are fixed to the column portions, and a rear end of the other plate surface is fixed to the support plate.

5. The lens driving device according to claim 1, wherein the soft magnetic member has a structure of fixing the driving shaft and the guide shaft.

6. A camera device comprising the lens driving device of claim 1.

7. An electronic apparatus comprising the camera device of claim 6.
